(19) United States
(12) Patent Application Publication
(10) Pub. No.: US 2025/0035815 A1
(43) Pub. Date: Jan. 30, 2025

(54) METHOD FOR DE-RISKING RESERVOIR ARCHITECTURE THROUGH SIMULATION OF FLUID CHARGE

(71) Applicant: Schlumberger Technology Corporation, Sugar Land, TX (US)

(72) Inventors: Morten Kristensen, Lysaker (NO); Francois Xavier Dubost, Paris (FR); Christopher Dorion, Denver, CO (US); Oliver C. Mullins, Houston, TX (US)

(21) Appl. No.: 18/777,851

(22) Filed: Jul. 19, 2024

Related U.S. Application Data
(60) Provisional application No. 63/515,379, filed on Jul. 25, 2023.

(51) Int. Cl. G01V 20/00; E21B 43/16

(52) U.S. Cl. CPC G01V 20/00; E21B 43/16; E21B 2200/20

(57) ABSTRACT

Embodiments presented provide for a method for using down hole fluid measurements for hydrocarbon recovery operation. In embodiments, the down hole fluid measurements are used to determine reservoir features to aid in calculations for the reservoir. Downhole fluid measurements may also be used to check the accuracy of a downhole geological architecture and fluid charge parameters, thereby providing a check on geological conditions.

### CROSS-REFERENCE TO RELATED APPLICATIONS

The present application claims priority to U.S. Provisional Patent Application 63/515,379, filed on Jul. 25, 2023, the entirety of which is incorporated by reference.

### FIELD OF THE DISCLOSURE

Aspects of the disclosure relate to hydrocarbon field recovery operations. More specifically, aspects of the disclosure relate to methods of de-risking reservoir architecture through simulations run to quantify fluid charge. In embodiments, a geological architecture is determined, a fluid charging profile is created and calculations are performed on what an expected fluid charge is that would be found for field conditions. Downhole fluid measurements may be used to cross-check the viability of the geological architecture and fluid charge profile. In further embodiments, wireline field measurements may be used to prepare the geological architecture or provide a simplified geological architecture.

### BACKGROUND

Understanding reservoir architecture (i.e., size and shape of compartments, vertical and lateral connectivity, etc.) is crucial for the design of an efficient field development strategy. Currently, reservoir architecture that is used to retrieve hydrocarbons is based mainly on educated operators conducting a pre-job plan and then mobilizing what is deemed to be necessary for retrieval of the hydrocarbons. Safety is paramount in such operations; therefore, the components selected for the operation are extensive.

The charging of hydrocarbon fluids happens over geologic time (thousands to millions of years) when the fluids migrate from source rocks into a subsurface enclosure (i.e., an oilfield reservoir). During hydrocarbon recovery operations, down hole fluid analysis is conducted to establish many properties of the field. To this end, there is a wealth of data available for analysis. Conventionally; however, understanding the overall fluid charge of a hydrocarbon field is accomplished through field experience. There is a need to be able to use present-day measurements of fluid distributions (from downhole fluid analysis and fluid samples acquired in exploration and appraisal wells) more efficiently.

While operations are conventionally carried out somewhat effectively, there is a need for improvement. For example, as older operators leave the oil field, the vast amounts of experience that they provide is not available for younger, less seasoned, operators to use. Also, as time progresses, deposits of hydrocarbons that are available to retrieve generally become smaller. This results in the need for more sets of equipment to be deployed for retrieval. As a consequence of such increases in equipment mobilization, the need to efficiently use the existing inventory of equipment is ever increasing. A numerical process or method is needed to allow for determining geological field properties without the guessing of experienced field workers. The numerical process or modeling should take into account both geological features and addition of fluids to the geological features to create an overall model that accurately predicts existing field conditions.

As field operators do not have unlimited resources of equipment in which to draw from, a prioritization schedule must be established for use of the equipment. Hydrocarbon projects are therefore, planned out long in advance. For instances of large fields, it is desired to be able to model such fields to determine the types of equipment to be used for ultimate removal of hydrocarbons.

Industry currently has been using various amounts of hydrocarbons; therefore, the overall cost of hydrocarbons, based on a free market economy, can vary significantly. The inability to quickly ramp up production to meet industry needs is currently a major drawback and needs to be more efficiently addressed so hydrocarbons may be brought to market quickly and efficiently. Knowing the extent and conditions of existing fields; however, is a long felt need for operators. There is a need for accurately predicting field conditions that have been developed by geological processes over time.

In conventional workflows, hypothesized reservoir architectures are either validated or falsified when the actual wells are drilled and production data becomes available. In practice, instead of working with a single model, this validation versus falsification step is often implemented as a pruning of the ensemble of models which represents the subsurface uncertainty. It is important to note; however, that it is only the movement of fluids in the reservoir that can reveal reservoir-scale connectivity. In a conventional workflow, such information only becomes available at the time of production, as well as from well testing measurements. There is a need to use the charge process of fluids entering the reservoir over geologic time as a source of information about reservoir-scale connectivity. Through this process, operators need a way to check a geological field expected charge and properties with the known features available through field investigation.

Conventional analysis or techniques for field development planning are also lacking. Field development planning as well as well placement and construction activities, benefit greatly if the underlying hydrocarbon reservoir may be accurately mapped and analyzed. For example, if analysis shows a local area of potentially greater hydraulic pressure for a reservoir, it may be more advantageous to conduct well placement activities in that area. Conventionally, well placement activities are chosen where actual samples are obtained. If an area is not completely evaluated, valuable hydrocarbon resources may not be recovered. If such resources can be recovered, the recovery may take greater amounts of equipment, such as pumps, to conduct the extraction. Similar difficulties may exist for wellbore completion and stimulation, as correct placement of a wellbore may require very little stimulation as well as minimal completion activities. Production may also be affected if little is known about the underlying reservoir. There is a need; therefore, to supplement existing field development planning technologies in order to improve hydrocarbon recoveries.

There is a further need to increase the efficiency of well placement and construction activities associated with hydrocarbon recoveries.

There is a further need to assist completion and stimulation activities through an approach that simulates fluid charge that may be present within the reservoir.

There is a still further need to provide for increased production activities associated with complex reservoirs.

There is a need to efficiently simulate reservoir architecture such that the simulation performed accurately predicts extraction that may be accomplished in the future.

There is a further need to “de-risk” the use of reservoir architecture such that the hydrocarbon recovery operations are subject to fewer unknowns, thereby allowing operators flexibility in operations for the removal process.

There is a still further need to minimize the backlog of hydrocarbon projects to meet the needs of industry by providing high quality geological models that accurately predict field conditions compared to conventional field analysis.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method of evaluation of a geological stratum through simulation of a fluid charge is disclosed. The method may comprise obtaining input data for the geological stratum. The method may further comprise obtaining field-based fluid distributions for a wellsite within the geological stratum. The method may further comprise preparing one of an assumed reservoir architecture, a well placement, a well completion technique, a well stimulation strategy and a well production plan for the wellsite within the geological stratum. The method may further comprise performing a dynamic simulation of a charge process for the geological stratum for the one of the assumed reservoir architecture, the well placement, the well completion technique, the well stimulation strategy and the well production plan for the wellsite to produce a result. The method may further comprise comparing the result to the field-based fluid distributions for the wellsite. The method may further comprise ending the method when the comparing of the result to the field-based fluid distributions for the wellsite is below a user-defined threshold value. The method may further comprise revising at least one of the reservoir architecture, a well placement, a well completion technique, a well stimulation strategy and a well production plan for the wellsite and the dynamic simulation of the charge process and returning to perform another dynamic simulation and comparing the result to the field-based fluid distributions for the wellsite until the ending of the method.

In another example embodiment an article of manufacture configured to store a set of instructions that may be performed on a computer is disclosed. In this embodiment, the article of manufacture may be configured having a non-volatile memory, the set of instructions comprising a method of evaluation of a geological stratum through simulation of a fluid charge. The method stored on the article of manufacture may comprise obtaining input data for the geological stratum. The method stored on the article of manufacture may also comprise obtaining field-based fluid distributions for a wellsite within the geological stratum. The method stored on the article of manufacture may also comprise preparing one of an assumed reservoir architecture, a well placement, a well completion technique, a well stimulation strategy and a well production plan for the wellsite within the geological stratum. The method stored on the article of manufacture may also comprise performing a dynamic simulation of a charge process for the geological stratum for the one of the assumed reservoir architecture, the well placement, the well completion technique, the well stimulation strategy and the well production plan for the wellsite to produce a result. The method stored on the article of manufacture may also comprise comparing the result to the field-based fluid distributions for the wellsite. The method stored on the article of manufacture may also comprise ending the method when the comparing of the result to the field-based fluid distributions for the wellsite is below a user-defined threshold value. The method stored on the article of manufacture may also comprise revising at least one of the reservoir architecture, a well placement, a well completion technique, a well stimulation strategy and a well production plan for the wellsite and the dynamic simulation of the charge process and returning to perform another dynamic simulation and comparing the result to the field-based fluid distributions for the wellsite until the ending of the method.

In one example embodiment, a method of evaluation for conducting hydrocarbon recovery operations through simulation of a fluid charge is disclosed. The method may comprise obtaining input data for an initial computer model of a hydrocarbon field. The method may further comprise obtaining field-based fluid distributions for a wellsite. The method may further comprise preparing a computer model of at least one of an assumed reservoir architecture, well placement, well completion, well stimulation and well production for the wellsite. The method may further comprise performing a computer-based dynamic simulation of a charge process for the model to produce a model result. The method may further comprise comparing the model result to field-based values for the wellsite. The method may further comprise ending the method when the comparing of model result to the field-based fluid distributions for the wellsite is below a threshold value to produce a final result. The method may further comprise revising at least one of the reservoir architecture, well placement, well completion, well stimulation and well production for the wellsite and the dynamic simulation of the charge process and returning to perform another dynamic simulation and comparing of the model result to the field-based fluid distributions for the wellsite until the ending of the method.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is an illustration of methodology to infer reservoir architecture from measurements of fluid distribution and dynamic simulation of fluid charge processes over geologic time.

FIG. 2 is an illustration of geological model building workflow.

FIG. 3 is a diagrammatic representation of a workflow diagram and applications that may use dynamic charge simulation

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second”, and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on”, “engaged to”, “connected to”, or “coupled to”, another element or layer, it may be directly on, engaged, connected, coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of methods described may be included onto a non-volatile memory system. For definitional purposes, a non-volatile memory system may be a memory system that does not wipe clean after termination of electrical power to the system. Examples of non-volatile memory systems may be compact disks, solid-state drives and universal serial bus devices. These memory systems may be used to store program executable method steps for a computer, server or computing arrangement.

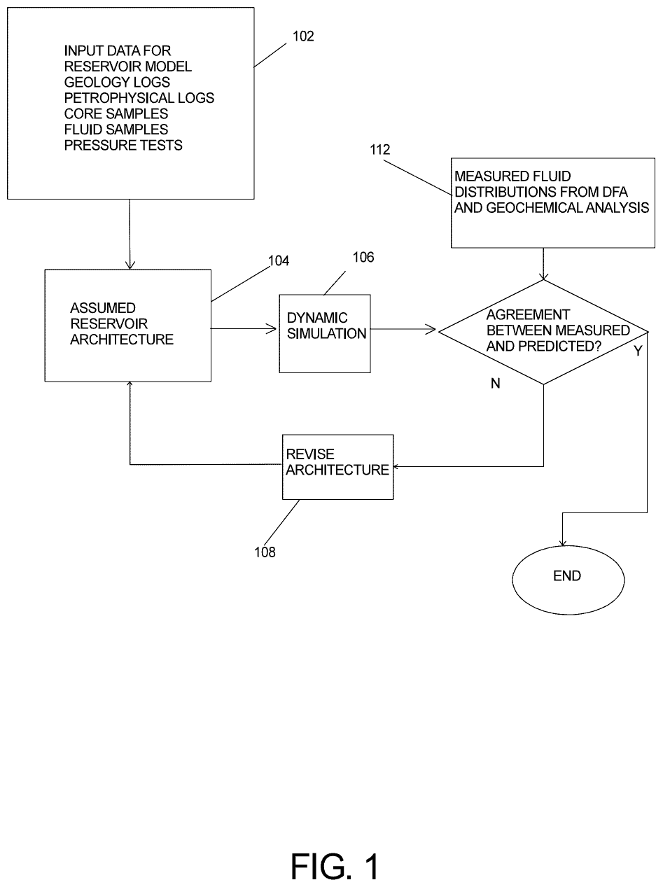

One example embodiment of the method 100 is illustrated in FIG. 1. At 102, input data for an initial model is obtained. At 104, a 3D geological model is constructed from various reservoir characterization measurements from the data obtained at 102, including (but not limited to) seismic surveys, wellbore logs, geological logs, petrophysical logs, pressure tests, fluid samples, and core samples obtained from the input data at 102. This initial model created, at 104, (or ensemble of models) represents a hypothesis about the reservoir architecture based on available information.

At 106, a dynamic simulation of a charge process is performed. At 106, the charge indicates an entering of fluids, such as hydrocarbons, entering the reservoir architecture. The model is run with the charge process and a hypothetical progression of time to achieve an end result for the charge process undergoing the geological process of time. This results in hydrocarbons being present in certain quantities and at certain pressures within the defined reservoir architecture. An end result is achieved after a hypothetical passage of time modeled. The method continues at 110, where a query determines if there is agreement between measured field data (run by actual physical tests in the field), obtained at 112, and predicted fluid distributions, or end result, at 106. This may be achieved, in one non-limiting embodiment, by establishing a threshold upon which acceptance of the model may be achieved. For example, the threshold may be model calculation results being within 99 percent of field measured properties. Other values may be used. The data obtained at 112 may include measured fluid distributions from downhole fluid analysis and geochemical analysis of fluid samples. If there is agreement between the predicted charge (at 106) and the measured fluid distributions from downhole fluid analysis and geochemical analysis of fluid analysis (at 112), then the method ends at 114. If there is no agreement, the method loops to 108 where reservoir architecture is changed/modified, and another dynamic simulation is performed at 106. In other instances, the charging process at 106 may be altered and fed back to the model 104. As will be further understood, both reservoir architecture and fluid charge may be changed at 108 and the model “rerun” in successive iterations. As will be understood, multiple amendments to the reservoir architecture at 108 may be performed to more accurately simulate the charge process within the hydrocarbon field. In some instances, data from field tests may be used to establish certain constraints in the geological model at 104. By using these constraints, an original model may be more accurate based on actual field findings. In such instances, the starting with an original model that is more accurate allows for definition of a finalized model quicker as non-viable model features are discarded at the start of the process.

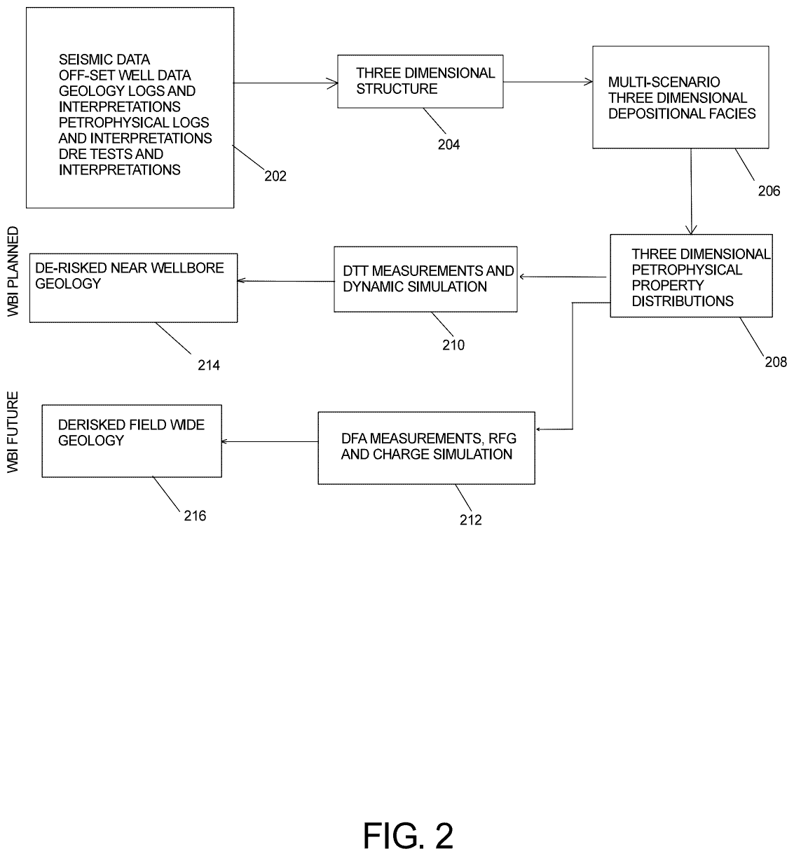

As illustrated in FIG. 1, an initial reservoir model is built using conventional modeling techniques (for example, using the steps illustrated in FIG. 2). Prior to charge, the reservoir, at 104, is filled with a fluid. In some embodiments, water may be used. In other embodiments, hydrocarbon based fluids may be used. A dynamic simulation is then carried out to simulate the charging of hydrocarbon fluids into the reservoir over thousands to millions of years. As the fluids enter the reservoir, the fluids will mix with previously charged fluids, inducing both convective and diffusive mixing. As will be understood, the hydrocarbons themselves may be altered by the geological processes occurring. In-reservoir mixing processes are also accounted for in the simulations. The outcome from the dynamic simulation is a prediction of the fluid distribution in the reservoir. This predicted distribution is then compared against measured distributions from downhole fluid analysis and from laboratory analysis of fluid samples. The fluid distribution characteristics, which are compared, include composition, asphaltene content, gas-oil-ratio, and geochemical metrics such as isotope ratios, among others. If agreement is obtained between measured and predicted fluid distributions, then this serves to validate the current hypothesis about reservoir architecture. If, on the other hand, the predicted and measured distributions do not agree, then the hypothesized reservoir architecture is less likely.

Revisions to the architecture may then be implemented and the workflow repeated until a satisfactory match is obtained as illustrated in FIG. 1. When used with production data, this process of adjusting a dynamic model to match observations is referred to as history matching. This is referred to as history matching of reservoir charge.

Aspects of the disclosure represent a new way to test geological models by integrating fluid measurements with the physics of fluid charging and mixing processes. This new method may be realized within computer applications, as illustrated in FIG. 2. Referring to FIG. 2, the method 200 includes, at 202, obtaining inputs of data that will be analyzed. The inputs 202 may include, seismic data, offset well data, geology logs, and interpretations and petrophysical logs and interpretations. In embodiments, other tests and interpretations may be obtained. At 204, the method continues with developing a three-dimensional structure. At 206, multi-scenario 3D depositional facies are developed. At 208, the method continues with determining three dimensional petrophysical property distributions. The method then provides for the simultaneous steps of conducting deep transient testing measurements and dynamic simulation at 210 and downhole fluid analysis measurement and reservoir fluid geodynamics and charge simulation at 212. From 210, the method continues with calculating a de-risked near wellbore geology, while proceeding from 212, a de-risked field wide geology is calculated. The result at 216 may be used, for example, at 104. As will be understood, for both FIG. 1 and FIG. 2, different wireline investigations may be used in help with determining the original model. Typical wireline investigations may include, but not be limited to, downhole fluid analysis, downhole seismic, high-definition NMR scans, dielectric scans, litho scanners, magnetic resonance scans, triaxial induction services, multi-function spectroscopy, full bore microimaging, high definition micro imaging, oil based microimaging, photorealistic reservoir geology services, ultrasonic borehole imaging, dipole shear sonic imaging, and acoustic sensing.

In one such embodiment of a computer application, the application serves to extract reservoir insights (such as connectivity, well productivity, in-place hydrocarbon volumes, etc.) by providing a 3D reservoir context for interpretation of wellbore measurements. As such, the workflow contains steps to construct candidate geological models which can be history matched, either against dynamic data from pressure transient tests (at 210), or against fluid measurements (at 212). While a pressure transient test may have a radius of investigation of, 200-500 hundred meters around the well in which the test is conducted, aspects of the present disclosure allow full reservoir-scale de-risking of candidate geological models through the integration of measurements from multiple wells along with the associated simulation of fluid charge and mixing which naturally involves the whole reservoir. After successive iterations are performed on models, field data may be used to accurately predict simplified geological architectures for analysis by operators. In one example embodiment, it may be found that fluid pressures above a certain prescribed limit indicate a specific layering of geological stratum to achieve these fluid pressures. In such instances, initial field tests may be able to define or constrain a geological model, thereby achieving superior results. In conventional analysis, field data is not used to develop a geological model to an accuracy hereby achieved.

As will be understood, the methods described above may be performed on a desktop computer, a computer server, a web-based server or cloud computing apparatus. In further embodiments, artificial intelligence may be used during different steps. For example, when models are required to be updated, experimental experience may be used to accurately change the models to allow for convergence of a solution.

Output of the models may be displayed on a computer screen or printed for operator review. Data may be stored on a non-volatile apparatus, such as hard disk drive, universal serial bus apparatus or solid-state hard drive.

Embodiments of the disclosure may be used in other endeavors. One such endeavor is during the early stages of exploration and appraisal for a hydrocarbon reserve. Often, data is limited regarding the reserve, and it is highly desired to appraise the reserve correctly as the amount of capital expended on the reserve will depend upon the size and quality of the hydrocarbons potentially recoverable.

At these stages of the project, a significant amount of uncertainty remains with respect to reservoir structure and connectivity. Aspects of the disclosure may be used to address the amount of uncertainty. In embodiments, a model may be generated to generate a predicted fluid distribution from charge simulation. These values may be compared to existing compositional gradients (and advanced laboratory fluid measurements) measured in the existing wells. It may be inferred if the assumed reservoir structure and connectivity is likely or not, based upon the results. In instances, the results will not match the field conditions. If this is encountered, the structural model may be changed.

In further embodiments, the prediction of fluid distributions can also inform local field engineers of the overall development concept for the field. For example, if the reservoir fluid has a high asphaltene content, then the asphaltenes may have precipitated and formed a tar mat at the oil-water contact, thus limiting the aquifer support and, therefore, requiring the drilling of injection wells for pressure support earlier in the life of the field. This is but one non-limiting example that the prediction of fluid distributions may be used for further characterization of field conditions. There are numerous other ways in which the understanding of fluid distributions will impact how a field is developed, including (but not limited to) choice of drainage strategy, placement of wells, and implementation of enhanced oil recovery techniques, among others.

In further embodiments, knowledge of fluid distributions can also influence the placement and construction of wells. In embodiments, charge simulation provides a prediction of fluid distributions in unexplored parts of the reservoir and may therefore be used to, for example: 1) target oil pockets, 2) avoid areas of high carbon dioxide or hydrogen sulfide concentration, 3) avoid areas with viscous oil or tar, or 4) target oil trapped below a tar deposit. For real-time geosteering applications the knowledge of fluid distributions, in conjunction with real-time information from fluid mapping while drilling, can be used to anticipate fluid changes ahead of the bit and actively steer the well accordingly.

Embodiments of the disclosure may also be used in completion and stimulation activities. In one example embodiment, once drilled, a well must be completed and, potentially, stimulated to initiate production. Fluid distribution information can be used to select sections of the well to complete (e.g., optimum perforation locations) and to design stimulation treatments.

Embodiments of the disclosure may also be used in production activities. The mixing of different fluids can give rise to flow assurance challenges, such as asphaltene deposition, wax/scale formation, and near-wellbore condensate drop-out. Again, quantitative knowledge about pre-production fluid distributions in the reservoir may be used to anticipate such challenges by simulating production scenarios over the production life of a field. Such production simulation is routinely done in the industry, but the advantage of combining this with charge simulation is the improved accuracy of the initial fluid state in the reservoir before production, thus leading to more accurate production predictions.

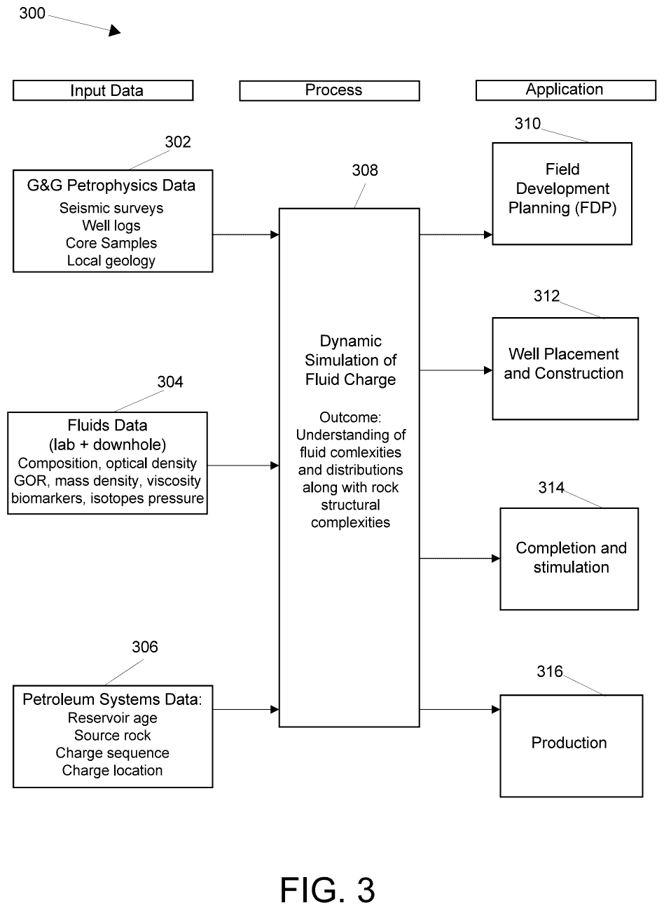

Referring to FIG. 3, a workflow diagram and applications that may use dynamic charge simulation are illustrated. At the top of FIG. 3, at 302, petrophysics data may be used as an input into the dynamic simulation of fluid charge at 308. Examples of petrophysics data that may be used include seismic surveys, well logs, core samples, and information related to local geology.

Further referring to FIG. 3, at 304, fluids data that may be obtained from a laboratory or from downhole analysis may also be used in the dynamic simulation of fluid charge at 308. Such fluid data may include fluid compositional analysis, optical density values, gas to oil ratio values, mass density, viscosity, biomarkers, and isotope pressures as non-limiting embodiments.

At 306, petroleum systems data may also be used as an input to the dynamic charge simulation at 308. Non-limiting data that may be used includes reservoir age, source rock, charge sequence and charge location.

Evaluation of the data provided from 302, 304 and 306 may be developed, as described above, by performing a dynamic simulation of fluid charge. This evaluation may provide hypothetical data as to the state of charge of the hydrocarbon field. The dynamic simulation 308 may be used in several instances. At 310, the data may be used in field development planning. At 312, the data may be used in well placement and construction. At 314, the data may be used in completion and stimulation. At 316, the data may be used in production activities.

As will be understood, the greater the amount of data obtained from field development planning 310, well placement and construction activities 312, completion and stimulation activities 314, or production activities 316, will produce more accurate results.

Aspects of the disclosure address difficulties that are present with conventional identification and analysis technologies. The aspects of the disclosure provide for a fundamental understanding of how fluids enter a reservoir. The analysis techniques also answer how these fluids mix with other fluids that may be in the hydrocarbon field. The distributions predicted are achieved by imposing and modeling the physics of fluid flow through processes such as diffusion and convection.

Example embodiments of the disclosure will now be disclosed. In one example embodiment, a method of evaluation of a geological stratum through simulation of a fluid charge is disclosed. The method may comprise obtaining input data for the geological stratum. The method may further comprise obtaining field-based fluid distributions for a wellsite within the geological stratum. The method may further comprise preparing one of an assumed reservoir architecture, a well placement, a well completion technique, a well stimulation strategy and a well production plan for the wellsite within the geological stratum. The method may further comprise performing a dynamic simulation of a charge process for the geological stratum for the one of the assumed reservoir architecture, the well placement, the well completion technique, the well stimulation strategy and the well production plan for the wellsite to produce a result. The method may further comprise comparing the result to the field-based fluid distributions for the wellsite. The method may further comprise ending the method when the comparing of the result to the field-based fluid distributions for the wellsite is below a user-defined threshold value. The method may further comprise revising at least one of the reservoir architecture, a well placement, a well completion technique, a well stimulation strategy and a well production plan for the wellsite and the dynamic simulation of the charge process and returning to perform another dynamic simulation and comparing the result to the field-based fluid distributions for the wellsite until the ending of the method.

In another example embodiment, the method may be performed wherein the input data includes at least one seismic survey.

In another example embodiment, the method may be performed wherein the input data includes at least one of geology logs and petrophysical logs.

In another example embodiment, the method may be performed wherein the input data includes core sample data.

In another example embodiment, the method may be performed wherein the input data includes fluid sample data.

In another example embodiment, the method may be performed wherein the input data includes pressure test data.

In another example embodiment, the method may be performed wherein the charge process occurs over a period of fluid exposure to geological processes.

In another example embodiment, the method may further comprise saving a final reservoir architecture in a non-volatile memory.

In another example embodiment, the method may further comprise printing characteristics of a final reservoir architecture.

In another example embodiment an article of manufacture configured to store a set of instructions that may be performed on a computer is disclosed. In this embodiment, the article of manufacture may be configured having a non-volatile memory, the set of instructions comprising a method of evaluation of a geological stratum through simulation of a fluid charge. The method stored on the article of manufacture may comprise obtaining input data for the geological stratum. The method stored on the article of manufacture may also comprise obtaining field-based fluid distributions for a wellsite within the geological stratum. The method stored on the article of manufacture may also comprise preparing one of an assumed reservoir architecture, a well placement, a well completion technique, a well stimulation strategy and a well production plan for the wellsite within the geological stratum. The method stored on the article of manufacture may also comprise performing a dynamic simulation of a charge process for the geological stratum for the one of the assumed reservoir architecture, the well placement, the well completion technique, the well stimulation strategy and the well production plan for the wellsite to produce a result. The method stored on the article of manufacture may also comprise comparing the result to the field-based fluid distributions for the wellsite. The method stored on the article of manufacture may also comprise ending the method when the comparing of the result to the field-based fluid distributions for the wellsite is below a user-defined threshold value. The method stored on the article of manufacture may also comprise revising at least one of the reservoir architecture, a well placement, a well completion technique, a well stimulation strategy and a well production plan for the wellsite and the dynamic simulation of the charge process and returning to perform another dynamic simulation and comparing the result to the field-based fluid distributions for the wellsite until the ending of the method.

In another example embodiment, the method of the article of manufacture is performed wherein the input data includes at least one seismic survey.

In another example embodiment, the method of the article of manufacture is performed wherein the method is performed wherein the input data includes at least one of geology logs and petrophysical logs.

In another example embodiment, the method of the article of manufacture is performed wherein the method is performed such that the input data includes core sample data.

In another example embodiment, the method of the article of manufacture is performed wherein the input data includes fluid sample data.

In another example embodiment, the method of the article of manufacture is performed wherein the input data includes pressure test data.

In another example embodiment, the method of the article of manufacture is performed wherein the charge process occurring in the method occurs over a period of fluid exposure to geological processes.

In one example embodiment, a method of evaluation for conducting hydrocarbon recovery operations through simulation of a fluid charge is disclosed. The method may comprise obtaining input data for an initial computer model of a hydrocarbon field. The method may further comprise obtaining field-based fluid distributions for a wellsite. The method may further comprise preparing a computer model of at least one of an assumed reservoir architecture, well placement, well completion, well stimulation and well production for the wellsite. The method may further comprise performing a computer-based dynamic simulation of a charge process for the model to produce a model result. The method may further comprise comparing the model result to field-based values for the wellsite. The method may further comprise ending the method when the comparing of model result to the field-based fluid distributions for the wellsite is below a threshold value to produce a final result. The method may further comprise revising at least one of the reservoir architecture, well placement, well completion, well stimulation and well production for the wellsite and the dynamic simulation of the charge process and returning to perform another dynamic simulation and comparing of the model result to the field-based fluid distributions for the wellsite until the ending of the method.

In another example embodiment, the method may be performed wherein the field-based values are used in at least one of field development planning, well placement and construction, wellbore completion, wellbore stimulation and wellbore production activities.

In another example embodiment, the method may be performed wherein the obtaining input data includes obtaining petrophysics data.

In another example embodiment, the method may be performed wherein the obtaining input data includes obtaining fluid composition data, optical density data, gas to oil ratio data, mass density data, viscosity biomarker data, and isotope pressure data.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method of evaluation of a geological stratum through simulation of a fluid charge, comprising:
obtaining input data for the geological stratum;
obtaining field-based fluid distributions for a wellsite within the geological stratum;
preparing one of an assumed reservoir architecture, a well placement, a well completion technique, a well stimulation strategy and a well production plan for the wellsite within the geological stratum;
performing a dynamic simulation of a charge process for the geological stratum for the one of the assumed reservoir architecture, the well placement, the well completion technique, the well stimulation strategy and the well production plan for the wellsite to produce a result;
comparing the result to the field-based fluid distributions for the wellsite;
ending the method when the comparing of the result to the field-based fluid distributions for the wellsite is below a user-defined threshold value; and
revising at least one of the reservoir architecture, a well placement, a well completion technique, a well stimulation strategy and a well production plan for the wellsite and the dynamic simulation of the charge process and returning to perform another dynamic simulation and comparing the result to the field-based fluid distributions for the wellsite until the ending of the method.

2. The method according to claim 1, wherein the input data includes at least one seismic survey.

3. The method according to claim 1, wherein the input data includes at least one of geology logs and petrophysical logs.

4. The method according to claim 1, wherein the input data includes core sample data.

5. The method according to claim 1, wherein the input data includes fluid sample data.

6. The method according to claim 1, wherein the input data includes pressure test data.

7. The method according to claim 1, wherein the charge process occurs over a period of fluid exposure to geological processes.

8. The method according to claim 1, further comprising:
saving a final reservoir architecture in a non-volatile memory.

9. The method according to claim 1, further comprising:
printing characteristics of a final reservoir architecture.

10. An article of manufacture configured to store a set of instructions that may be performed on a computer, the article of manufacture having a non-volatile memory, the set of instructions comprising a method of evaluation of a geological stratum through simulation of a fluid charge comprising:
obtaining input data for the geological stratum;
obtaining field-based fluid distributions for a wellsite within the geological stratum;
preparing one of an assumed reservoir architecture, a well placement, a well completion technique, a well stimulation strategy and a well production plan for the wellsite within the geological stratum;
performing a dynamic simulation of a charge process for the geological stratum for the one of the assumed reservoir architecture, the well placement, the well completion technique, the well stimulation strategy and the well production plan for the wellsite to produce a result;
comparing the result to the field-based fluid distributions for the wellsite;
ending the method when the comparing of the result to the field-based fluid distributions for the wellsite is below a user-defined threshold value; and
revising at least one of the reservoir architecture, a well placement, a well completion technique, a well stimulation strategy and a well production plan for the wellsite and the dynamic simulation of the charge process and returning to perform another dynamic simulation and comparing the result to the field-based fluid distributions for the wellsite until the ending of the method.

11. The article of manufacture according to claim 10, wherein the method is performed wherein the input data includes at least one seismic survey.

12. The article of manufacture according to claim 10, wherein the method is performed wherein the input data includes at least one of geology logs and petrophysical logs.

13. The article of manufacture according to claim 10, wherein the method is performed such that the input data includes core sample data.

14. The article of manufacture according to claim 10, wherein the input data includes fluid sample data.

15. The article of manufacture according to claim 10, wherein the input data includes pressure test data.

16. The article of manufacture according to claim 10, wherein the charge process occurring in the method occurs over a period of fluid exposure to geological processes.

17. A method for conducting hydrocarbon recovery operations through simulation of a fluid charge, comprising:
obtaining input data for an initial computer model of a hydrocarbon field;
obtaining field-based fluid distributions for a wellsite;
preparing a computer model of at least one of an assumed reservoir architecture, well placement, well completion, well stimulation and well production for the wellsite;
performing a computer-based dynamic simulation of a charge process for the model to produce a model result;
comparing the model result to field-based values for the wellsite;
ending the method when the comparing of model result to the field-based fluid distributions for the wellsite is below a threshold value to produce a final result; and
revising at least one of the reservoir architecture, well placement, well completion, well stimulation and well production for the wellsite and the dynamic simulation of the charge process and returning to perform another dynamic simulation and comparing of the model result to the field-based fluid distributions for the wellsite until the ending of the method.

18. The method according to claim 17, wherein the field-based values are used in at least one of field development planning, well placement and construction, wellbore completion, wellbore stimulation and wellbore production activities.

19. The method according to claim 17, wherein the obtaining input data includes obtaining petrophysics data.

20. The method according to claim 17, wherein the obtaining input data includes obtaining fluid composition data, optical density data, gas to oil ratio data, mass density data, viscosity biomarker data, and isotope pressure data.
